(19) United States
(12) Patent Application Publication
(10) Pub. No.: US 2023/0115626 A1
(43) Pub. Date: Apr. 13, 2023

(54) SOLID ELECTROLYTE BATTERY

(71) Applicant: COMMISSARIAT A L'ENERGIE ATOMIQUE ET AUX ENERGIES ALTERNATIVES, Paris (FR)

(72) Inventors: Jean-Philippe COLONNA, Grenoble Cedex 09 (FR); Jean BRUN, Grenoble Cedex 09 (FR); Sami OUKASSI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/938,783

(22) Filed: Oct. 7, 2022

(30) Foreign Application Priority Data
Oct. 11, 2021 (FR) 21 10702

(51) Int. Cl. H01M 10/0585; H01M 10/0562; H01M 50/562

(52) U.S. Cl. CPC H01M 10/0585; H01M 10/0562; H01M 50/562

(57) ABSTRACT

A battery includes, stacked successively above a first face of a support, in a stacking direction, at least a cathode including a lower face, an upper face and a side wall directed in the stacking direction from the lower face to the upper face, a solid electrolyte, an anode, the battery including a coating portion surrounding, and in contact with, all of the side wall of the cathode, without covering the upper face of the cathode.

### TECHNICAL FIELD

The present invention relates to the field of electrochemical devices, in the field of storing energy electrochemically. This relates to solid battery-form electrolyte devices, advantageously of the microbattery-type, small in size, i.e. less than 10 cm², even less than 1 cm².

The invention has an advantageous application in manufacturing microelectronic devices. By microelectronic device, this means any type of device made with microelectronic means. These devices in particular comprise, in addition, devices with a purely electronic purpose, micromechanical or electromechanical devices (MEMS, NEMS, etc.), as well as optical or optoelectronic devices (MOEMS, etc.).

### STATE OF THE ART

A microbattery is an electrochemical device composed of two electrodes (positive and negative, also called respectively cathode and anode), separated by an electrical insulator (the electrolyte).

A solid microbattery is defined according to the current state of the art as being a battery which comprises the following features:
all the active layers (i.e. the positive electrode, the electrolyte, the negative electrode) are made only of materials in the solid state, of inorganic nature;
typically, this means that there is no electrolyte made of polymer, liquid- or gel-form material and not of electrode materials which contain polymer binders as is the case in standard batteries;
the individual thickness of all the active layers (i.e. the positive electrode, the electrolyte and the negative electrode) is less than 50 μm. In addition, the electrolyte thickness is usually less than 5 μm. For standard batteries, the thickness of each of these layers is usually greater than 100 μm;
the surface area of a microbattery is generally between 1 mm² to 10 cm².

The miniaturisation of mobile devices (connected objects, medical implants, etc.) involves being able to produce small-sized energy sources (in particular a few mm²) capable of storing a sufficient quantity of energy. The capacity of a battery is directly proportional to the volume of the positive electrode, typically made of lithiated cobalt oxide, of chemical formula LiCoO₂, often abbreviated to Lico or LCO.

In a conventional manufacture of microbatteries, as FIG. 1 shows, illustrating a typically microbattery stack, a stack is made by successive depositions on a support 1 of a first current collector 2, of a first electrode 3, of an electrolyte 4 (or ionic conductor), of a second electrode 5, and of a second current collector 6 (which can take the form of a current redistribution line. An encapsulation, by way of deposition of one or more additional protective layers 16, or by transfer of cap, is often necessary to protect the system from chemical reactivity with oxygen and water vapour. The collectors 2, 6 each have a contact reconnection portion, remaining accessible through the outside of the stack of the microbattery for the electrical connection of the latter. A cavity 161 in the protective layer 16 can serve the second collector 6, to reach the anode 5.

The migration of one or more ions between the two electrodes 3, 5 through the electrolyte 4 makes it possible, either to store energy, or to delivery to an external circuit.

The manufacture of such a structure currently causes defects, especially when a significant cathode thickness is sought, which is often the case insofar as this directly conditions the capacity of the battery. However, a significant roughness on the surface of the cathode is observed, and this all the more so than its thickness being large. For example, Lico has a very columnar structure with a granular surface.

Generally, and independently from the question of roughness of the surface of the cathode, seeking a significant cathode thickness induces manufacturing difficulties and structural disadvantages.

An aim of the present invention is therefore to propose an improve battery and a method for its manufacture.

Other aims, features and advantages of the present invention will appear upon examining the following description and accompanying drawings. It is understood that other advantages can be incorporated.

### SUMMARY

To achieve this objective, according to an embodiment, a battery is provided, comprising, stacked successively above a first face of a support, in a stacking direction, at least:
one cathode comprising a lower face, an upper face and a side wall directed in a stacking direction from the lower face to the upper face,
one solid electrolyte,
one anode.

Advantageously, the battery comprises a coating portion surrounding, and in contact with, all of the side wall of the cathode, without covering the upper face of the cathode.

Thanks to the coating portion, the cathode is buried, i.e. girdled by an element which surrounds it. This arrangement induces at least one of the following advantages.

The mechanical strength of the cathode can be increased by the lateral reinforcement that it has, thanks to the coating portion; this can, in particular, be useful during manufacturing phases, for example if the upper face of the cathode is mechanically worked, for example by polishing, to improve its surface condition; this reinforcement can also be useful after manufacture, to increase the maintaining of the cathode on the support, in particular when significant cathode thicknesses are reached.

Optionally, the coating portion can be obtained after deposition of a coating layer covering the upper face of the cathode, followed by a removal, comprising a mechanical action, of the part of the coating layer covering the upper face of the cathode.

Another potential interest of the coating portion is to have a peripheral zone on the upper face of the cathode located at one same level, the coating portion being flush with the upper face; thus a deposition zone of other layers is had (in particular, but not in a limiting manner, an electrolyte and an anode), which offers less manufacturing constraints than hollow deposition surfaces as would be the case if the cathode was in relief relative to the zone which surrounds it; according to a possibility, at least some of the upper face of the coating portion is flat and in the continuity of the upper face of the cathode, so as to form a flat assembly, preferably directed perpendicularly to the stacking direction, the surface of this assembly being particularly favourable to the deposition of the subsequent layers to make the battery.

Another aspect relates to a method for manufacturing a battery, comprising a formation of a stack successively comprising, in a stacking direction, on a first face of a substrate, at least:
one cathode comprising a lower face, an upper face and a side wall directed in the stacking direction from the lower face to the upper face,
one electrolyte,
one anode,
   further comprising the formation of a coating portion surrounding, and in contact with, all of the side wall of the cathode, without covering the upper face of the cathode.

Another aspect also relates to a system comprising a plurality of batteries. The latter can be juxtaposed and/or superposed.

Another aspect is a microelectronic device comprising at least one battery.

### BRIEF DESCRIPTION OF THE FIGURES

The aims, objective, as well as the features and advantages of the invention will emerge best from the detailed description of an embodiment of the latter, which is illustrated by the following accompanying drawings, wherein:

FIG. 1 represents an example of a stack of an electrochemical device forming a solid electrolyte battery according to the state of the art.

FIGS. 2 to 13 have a succession of steps of making a battery according to an embodiment.

FIG. 14 has an example of a battery system, the latter being superposed.

FIGS. 15 to 18 have another continuation of steps of making a battery.

FIG. 19 has an example of a battery stack, the latter being superposed.

FIG. 20 shows an example of formation, in a plate, of a plurality of batteries.

FIGS. 21A, 21B, 21C have examples of levels of batteries in a battery superposition configuration.

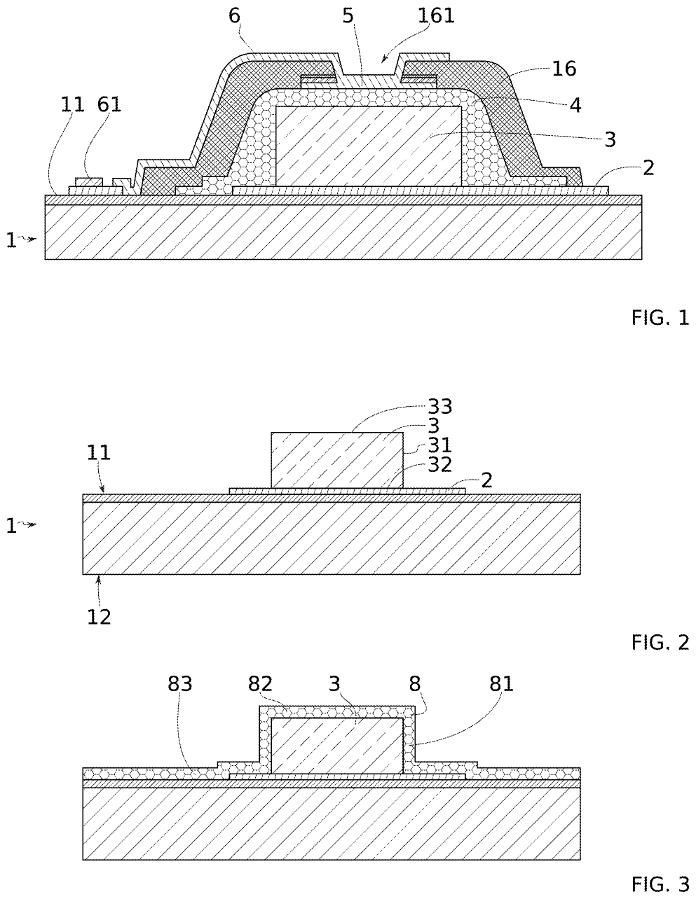

The drawings are given as examples and are not limiting of the invention. They constitute principle schematic representations intended to facilitate the understanding of the invention and are not necessarily to the scale of practical applications. In particular, the thicknesses are not necessarily representative of reality.

### DETAILED DESCRIPTION

Before starting a detailed review of embodiments of the invention, below are stated optional features which can optionally be used in association or alternatively:
According to an example, the upper face 33 of the cathode 3 is flat and the coating portion comprises an upper face 71 having at least one flat portion in the continuity of the upper face 33 of the cathode 3;
According to an example, the coating portion comprising a main portion 72 made of a first material and a contact coating 73, made of a second material different from the first material, the contact coating 73 being in contact with the side wall 31 of the cathode 3 and disposed between the main portion 72 and the side wall 31 of the cathode 3;
According to an example, at least one electrical connection element 9 crosses through the coating portion and leads to an upper face 71 of the coating portion;
According to an example, the at least one electrical connection element 9 comprises at least one terminal 92 made of an electrically conductive material, and in particular of a soldering material, or also of a material which is deposable by electrolysis, in particular copper-based, or also a material which is weldable on its support, like an aluminium terminal;
According to an example, the at least one electrical connection element 9 leads to a second face 12 of the support 1, opposite the first face 11;
According to an example, a first current collector 2 in electrical continuity with the cathode 3, a second current collector 6 in electrical continuity with the anode 5 and the at least one electrical connection element 9 comprises at least one first electrical connection element 9 connected to the first current collector 2 and at least one second electrical connection element 9 connected to the second current collector 6;
The invention also relates to a system comprising a plurality of batteries such as described above.
at least two batteries are optionally superposed;
at least one electrical connection element 9 of one of the batteries is in electrical continuity with an electrical connection element 9 of at least one other of the batteries.
According to a possible aspect of the method, the formation of the coating portion comprises:
   a formation of a coating layer so as to fully cover the cathode 3;
   a thinning of the coating layer until exposing the upper face 33 of the cathode 3, the thinning comprising at least one polishing phase.
the formation of a coating layer comprises the formation of a coating layer 8 made of a first material on, and in contact with, the cathode 3, then the formation of a main layer 7 made of a second material, different from the first material, on, and in contact with, the coating layer 8.
the first material is chosen more mechanically resistant to polishing than the second material.
the polishing is applied to the main layer 7, by using the coating layer 8 as a polishing stop layer.
an etching of the coating layer 8 is comprised, after polishing, to expose the upper face 33 of the cathode 3.
the polishing is applied until exposing the upper surface 33 of the cathode 3.
Optionally, the method comprises the formation of at least one electrical connection element 9, and wherein the polishing is configured to expose the at least one electrical connection element 9 on the upper face 33 of the coating portion.
Optionally, the method comprises a thinning of the support 1 by a second face 12 of the support 1 opposite the first face 11, the thinning being configured to expose the at least one electrical connection element 9 on the second face 12 of the support 1.

It is specified that, in the scope of the present invention, the term “on” or “above” does not compulsorily mean “in contact with”. Thus, for example, the deposition of a layer on another layer, does not compulsorily mean that the two layers are directly in contact with one another, but this means that one of the layers covers at least partially the other by being, either directly in contact with it, or by being separated from it by a film, or also another layer or another element. That being said, the layers of first collector, of first electrode, of electrolyte, the second electrode and of second collector are stacked preferably with successive contact surfaces. A layer does not necessarily cover the whole surface of an underlying part.

A layer can moreover be composed of several sublayers made of one same material or of different materials.

By a substrate, an element, a layer or other “with the basis” of a material M, this means a substrate, an element, a layer comprising this material M only, or this material M and optionally other materials, for example alloy elements, impurities or doping elements. If necessary, the material M can have different stoichiometries.

It is specified that in the scope of the present invention, the thickness of a layer or of the substrate is measured in a direction perpendicular to the surface according to which this layer or this substrate has its maximum extension. The stack of the electrochemical device is performed in this direction. A lateral direction extends as directed perpendicularly to the thickness of the substrate.

Certain parts of the device of the invention can have an electrical function. Some are used for electrical conduction properties and by electrode, collector or equivalent, this means elements formed of at least one material having a sufficient electrical conductivity, in the application, to achieve the desired function. Conversely, by electrical or dielectric insulator, this means a material which, in the application, ensures an electrical insulation function.

By battery, this means an element for storing and destocking electrical energy: it comprises a stack of components, with a cathode, a solid electrolyte and an anode. This battery can be of reduced size such as is referred to as a microbattery, for example, if the contact surface between the cathode and the electrolyte, in projection in the stacking direction, is less than 1 cm², even 20 mm² or even 10 mm².

A battery assembly, all according to the invention or not, can be made. In particular, by superposing the batteries in the stacking direction of their layers. Certain conductive elements can serve, through a given battery, to electrically connect at least one other battery of the assembly.

Before providing embodiment details, in particular based on illustrations, general comments on aspects of the invention are formulated below.

The coating portion can be made of several sub-portions. For example, it comprises a sub-portion, also here called contact coating portion, intended to be in direct contact with the cathode. Without this being limiting, it can be thinner than the rest of the coating portion. Preferably, this sub-portion comes from a deposition according to material, to quite regularly mould the contour of the cathode. The coating portion can extend over the first face of the support.

The coating portion can complementarily comprise a main portion, extending laterally from the coating portion. This portion can be more voluminous than the other, and in particular can fill the whole volume surrounding the cathode, over a height identical to the thickness of the cathode. It can be from a “solid plate” formation of a coating layer, over a thickness greater than the desired final thickness.

According to another possibility, the coating portion comprises more than two portions, for example from several layers formed successively on the surface of the support and on the cathode.

But, the coating portion can also only be formed of a portion, made of one single material, in particular from one single step of forming the coating layer.

The coating layer from which the coating layer comes, covers the whole cathode, even though the latter is thus no longer exposed at all. However, this does not necessarily imply that all the layers formed initially to create the coating portion cover the whole surface of the cathode. In particular, the formation layer of the contact coating portion can be sufficiently thin to not absorb the whole relief of the upper face of the cathode, the latter being able to have a significant roughness at this manufacturing phase. It is possible that cathode material ridges subsist projecting from the coating layer at this stage. The coating layer can serve to consolidate this zone, awaiting the polishing which will follow. The ridges will thus progressively have their tops removed, without their base being broken.

Alternatively, the contact coating layer can cover the upper face of the cathode such that no element of the relief of this face remains exposed; even in this case, the coating layer is, for this relief that it moulds, a mechanical reinforcement that can be assessed for the polishing.

The electrical connection elements 9 extend from the whole structure, configured to conduct electricity between two points. The structures illustrated are only examples. More generally, these elements can, for some, serve to electrically connect the cathode, preferably via a first current collector, of at least one battery. Others are intended to electrically connect the anode, preferably via a second collector, of at least one battery. These elements preferably have a main dimension directed in the stacking direction.

A sealing structure is advantageously formed to insulate one or more batteries from their environment. It preferably forms a closed frame around the stack. This structure can be formed by assembling two sealing elements each formed, respectively on a first battery and on a second battery, on faces opposite one another.

FIGS. 2 to 13 illustrate a first example of successive steps making it possible to reach a battery according to the invention.

A support 1 forms the starting element. It can be a plate made of semi-conductive material, particularly silicon. However, other substrates are possible, for example made of glass. Moreover, and particularly if the support comprises a base made of electrically conductive material, it can comprise a superficial layer made of an electrically insulating material, typically of silicon dioxide for a silicon support base 1.

The support 1 will allow the production, in stacks, of a plurality of components of the battery. Unless it is otherwise disposed below in the description, the formation of these components can implement layer deposition photolithography and etching steps to obtain the desired component pattern. Typically, for the deposition of layers of the stack, a physical vapour deposition (PVD) technique can be used.

A first face 11 of the support carries a first current collector 2. The current collector 2 is connected to its electrode, here the cathode 3, so as to establish an electrical continuity between these two parts; this collector extends generally laterally beyond the cathode 3, outwards from the encapsulated device.

As an example, the first collector 2 comprise at least one metal layer, for example titanium- and/or platinum-based. In particular, it can first comprise a thin titanium dioxide layer followed by a platinum layer.

The stack continues with the formation of the cathode 3.

The material of the first electrode 3 can be LiCoO₂ (as indicated above). Further, below are given examples of materials which can also be used for the first electrode 3: V₂O₅, TiS₂, LiMn₂O₄, NaMnO₂, NaCoO₂. After the formation of the pattern of the cathode 3, this generally undergoes an annealing.

Preferably, the thickness of the cathode 3 is greater than or equal to 10 μm, even to 20 μm. Optionally, this thickness can be less than or equal to 70 μm. Subsequently, it will be seen that such significant thicknesses can be achieved, thanks to the invention by the structural and/or manufacturing provisions implemented. It will be noted that, at this step, the cathode 3 potentially represents a significant overlift above the first face 11 of the substrate 1. It comprises a side part 31 extending preferably in the direction of the stack of the components of the battery (typically the dimension in thickness of the support 1), a lower face 32 in contact with the first collector 2 and an upper face 33, opposite the lower face 32. The upper face 33 is advantageously flat along a plane perpendicular to the stacking direction.

Usually, the manufacture would continue by the implementation of an electrolyte directly above the cathode 3. However, as FIG. 3 shows, it is proposed here to form beforehand a coating portion of the cathode 3.

To achieve this, in the embodiment of FIG. 3, it is started by forming a contact coating layer 8 configured to fully cover the cathode 3. However, it must be noted that the formation of the layer 8 is not essential. Indeed, the coating portion can be made without resorting to this step.

The layer 8 has a side part 81 covering the side 31 of the cathode 3, an upper part 82 covering the upper face 33 of the cathode 3, and a basal part 83 disposed above the face 11 of the support.

As indicated above, it is however possible that roughness, in particular ridges of the relief of the upper face 33, remain projecting beyond the contact coating layer 8. Preferably, the coating layer 8 also covers the rest of the face 11 of the support. This layer can be of mineral nature—for example, made of TEOS (tetraethyl orthosilicate), SiN, SiON, or of organic nature (for example, with a polymer which is photosensitive or not, such as parylene). The contact coating layer 8 can be formed of several sublayers of different materials, for example according to the examples given above. The thickness of the coating layer 8 can be greater than or equal to 200 nanometres and/or less than or equal to 10 μm.

A first potential interest of the coating layer 8 is to serve as a stop layer of a subsequent thinning phase comprising a polishing, described in detail below. Alternatively, or complementarily, this layer 8 can have a protective role in order to avoid the removal of the grains from the material of the cathode 3, typically Lico.

As indicated above, the material of the cathode 3, especially when the latter is thick, can have on its exposed surface, irregularities typically in the form of tips. According to a non-limiting aspect of the invention, the layer 8 serves to maintain the tips during the thinning of the main coating layer 7. In particular, the thickness of the layer 8 can be less than the maximum height of the tips, and can, for example, represent between 30% and 75% of the maximum height of the tips. In this case, these tips project beyond the layer 8, and are then covered by the layer 7. They are maintained laterally by the layer 8 during the thinning of the layer 7 which also leads to the consumption of the end projecting from the tips, without removing them at their base. Even if the base of the tips subsists, the relief of the cathode 3 is clearly reduced from it.

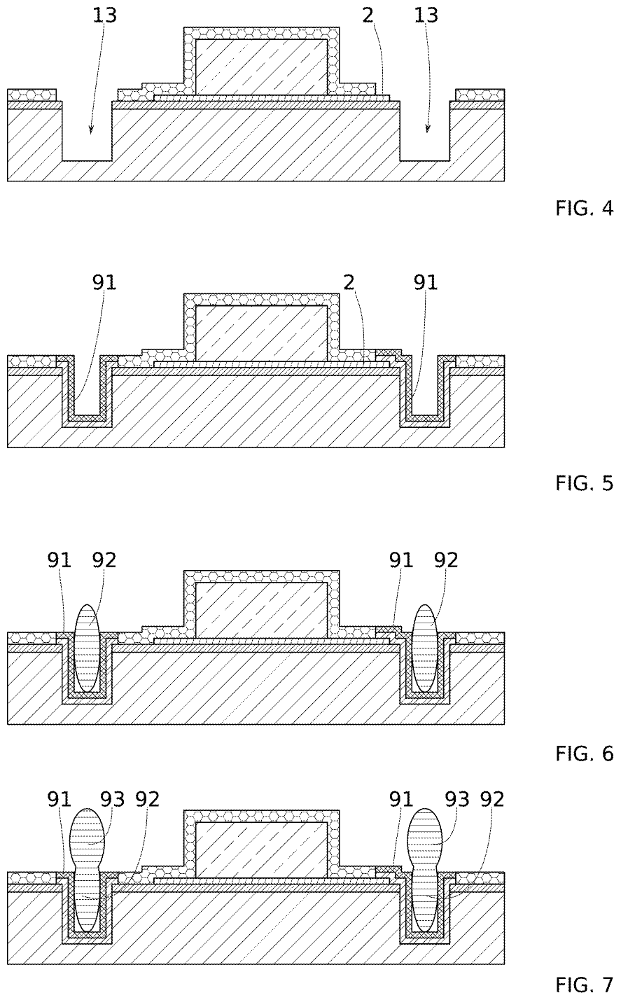

According to a possibility, parallel to the formation of the stack of the battery, at least certain steps of making electrical connection elements 9 are carried out. It is what FIG. 4 reflects, wherein one or more cavities 13, for example in the form of trenches, are made in the support 1, by crossing through the coating layer 8. Etching steps can be implemented for this purpose, or also a saw cut. Preferably, this shaping is configured to expose a portion of the first collector 2 laterally, relative to the layer 8, to make it accessible.

FIG. 5 has a following step, wherein an electrically conductive part is made in the cavity 13, in the form of wall portion 91, which can come from a metallisation. A titanium and gold bilayer can, for example, be resorted to. The portion 91 can cover all of the surface of the cavity 13. For at least some electrical connection elements 9, the portion 91 can be in contact with the first collector 2, for the electrical connection of the cathode 3. As indicated above, other electrical connection elements 9 can have other functions, in particular for the electrical connection of the anode 5. In the representation of FIG. 5, the portion 91 illustrated to the right of the cathode serves as the connection of the first collector 2; the portion 91 illustrated to the left of the cathode is not connected to the first collector 2, and can serve as the connection of the anode 5 via a second collector 6. Moreover, and particularly when the support 1 is electrically conductive, an electrically insulating layer can also be deposited before forming the portion 91; this insulating layer can be etched to establish the electrical contact of the portion 91 with the collector 2.

The formation of electrical connection elements 9 can continue, for each element 9, by making a terminal 92 made of electrically conductive material, in contact with the portion 91, in particular to fill at least partially the cavity 13, and, preferably, to form an element projecting beyond it.

A lead- and/or tin-based material can typically be used for the terminal 92, according to the technology known as “bump”. This solution is relatively inexpensive. Also, and in particular, if such bumps have a “stud bump”-type shape, the terminal 92 can be made of gold or of aluminium.

To increase the height of the electrical conduction element 9, the manufacture advantageously comprises an additional phase of forming at least one second terminal 93 in the electrical continuity, and above, the terminal 92, as FIG. 7 shows. It is understood that the structure obtained projects beyond the first face 11 of the support 11, laterally to the stack comprising the cathode 3. Preferably, the height of this structure is, at this step, greater than or equal to, and preferably strictly greater than, the height of the upper face 33 of the cathode 3.

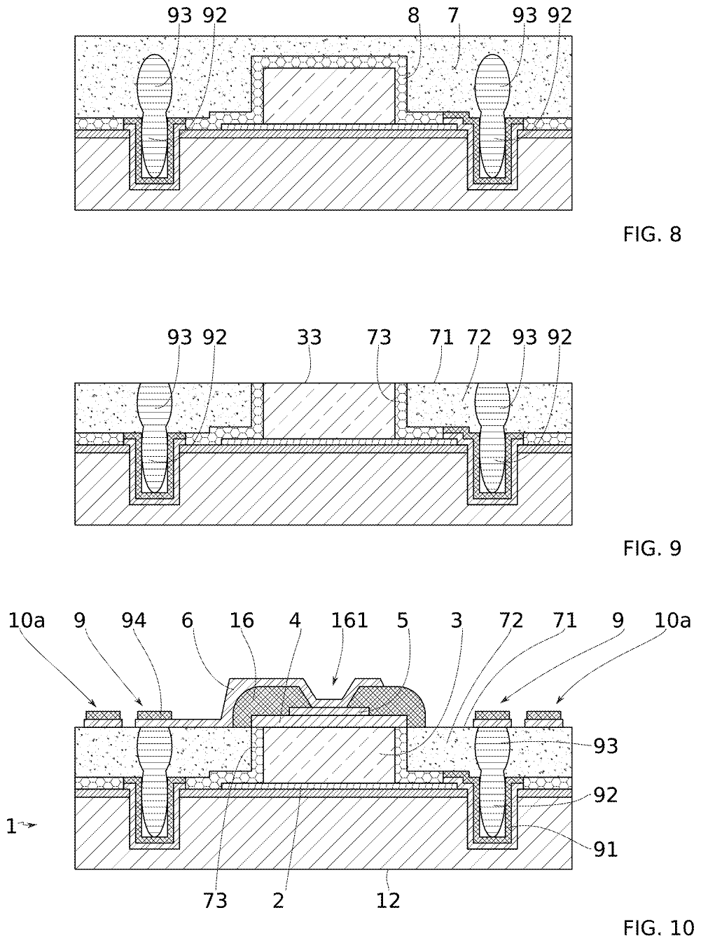

FIG. 8 shows the formation of a main coating layer 7 which covers all the elements previously formed on the first face 11 of the support 1.

According to a possibility, the layer 7 can be obtained by moulding, for example by flattening a mould against the device and by performing an injection of polymer material, at a sufficient temperature. Lamination can also be resorted to, by laminating a film above the coating layer 8 and by proceeding with the creep of the laminated material by increasing temperature. It is understood that the cathode 3 is thus fully insulated from the outside by the coating formed, in the example illustrated, of the coating layer 8 and of the main layer 7.

On this basis, a thinning of this coating is proceeded with, until obtaining the configuration of FIG. 9. In this figure, the upper face 33 of the cathode 3 is exposed, but the rest of its wall remains protected by a coating portion 72, 73 formed by the residual parts of the contact coating layer 8 and of the main coating layer 7.

To reach such a configuration, the thinning comprises a polishing. This can be a solely mechanical action, such as a grinding or dry polishing, or a mechanical and chemical action, such as a chemical-mechanical polishing implementing, simultaneously, a mechanical etching and a chemical etching by a solution adapted to the etching of at least one of the coating materials.

According to a possibility, the polishing is done to thin the main coating layer 7, by using the upper part of the contact coating layer 8 as a stop layer. In this configuration, the polishing can be successfully completed by delicately stopping on the coating 8.

Optionally, the coating 8 can be thinned, at a lesser speed, during the polishing, to progressively reduce the roughness of the upper face 33 of the cathode 3. Preferably, in this context, the material chosen for the layer 8 is more mechanically resistant to polishing (harder, in particular) than the material chosen for the layer 7.

According to a first possibility, the polishing ensures the exposure of the face 33 of the cathode 3. Either by its mechanical action on the assembly of the coating, or by its mechanical action completed by a chemical action targeting the coating layer 8.

According to another possibility, the polishing is stopped before exposing the face 33. The upper part of the layer 8 is thus removed by etching, which can be a dry etching or a wet etching.

The configuration obtained, which can be seen in FIG. 9, shows that the cathode 3 is maintained laterally by the coating portion comprising a contact coating 73 from the contact coating layer 8, and a main coating portion 72, from the main coating layer 7.

In the case where the steps described above are implemented to thin the coating, a flat upper face 71 is obtained for the coating portion. The upper face 71 is moreover flush with the upper face 33 of the cathode 3. The illustration shows a certain lateral extension of the coating portion 72, 73, but it can be more limited. However, it covers the whole height of the cathode 3 at least over a certain distance, laterally, from the latter.

FIG. 9 shows, moreover, that the electrical connection element parts 9 formed beforehand, in particular the terminals 93, have been exposed, thanks to the thinning. Thus, the elements 9 are also advantageously buried in the coating portion 72, 73, and their exposure is done without any additional step.

Thus, making the battery stack is continued. In FIG. 10, from the upper face 33 of the cathode 3 and of the upper face 71 of the coating portion, an electrolyte 4, an anode 5, a protective layer 16 and a second collector 6 are successively formed. Insofar as a flat surface is benefited from for these additional actions, the manufacture is simplified, in particular because the cathode 3 is no longer in relief relative to the first face 11 of the support 1 which is generally a topography which is detrimental to the implementation of layer depositions.

The electrolyte 4 is advantageously made by a solid ionic conductor. This can be LiPON.

In a configuration wherein the surface of the cathode 3 and its environment form a flat zone, the anode 5 can be wider than in a standard configuration, and in particular wider than the cathode 3; this can be advantageous from the standpoint of the electrostatic control. The anode 5 can, for example, be made of metal conductor, in particular titanium. The second collector which covers it can preferably be made of copper or of titanium or of any other electrically conductive material, preferably metal. As indicated above, an opening 161 in the protective layer 16 can allow the electrical connection of the anode 5, while maintaining the stack protected by the protective layer 16. The latter is, for example, made of polyparaxylylene.

For the connection of the anode 5, the formation of the second collector 6 can be configured to connect it to at least one electrical connection element 9, typically that represented on the left in FIG. 10. The electrical connection can be finalised by a contact reconnection element 94, for example, made of gold.

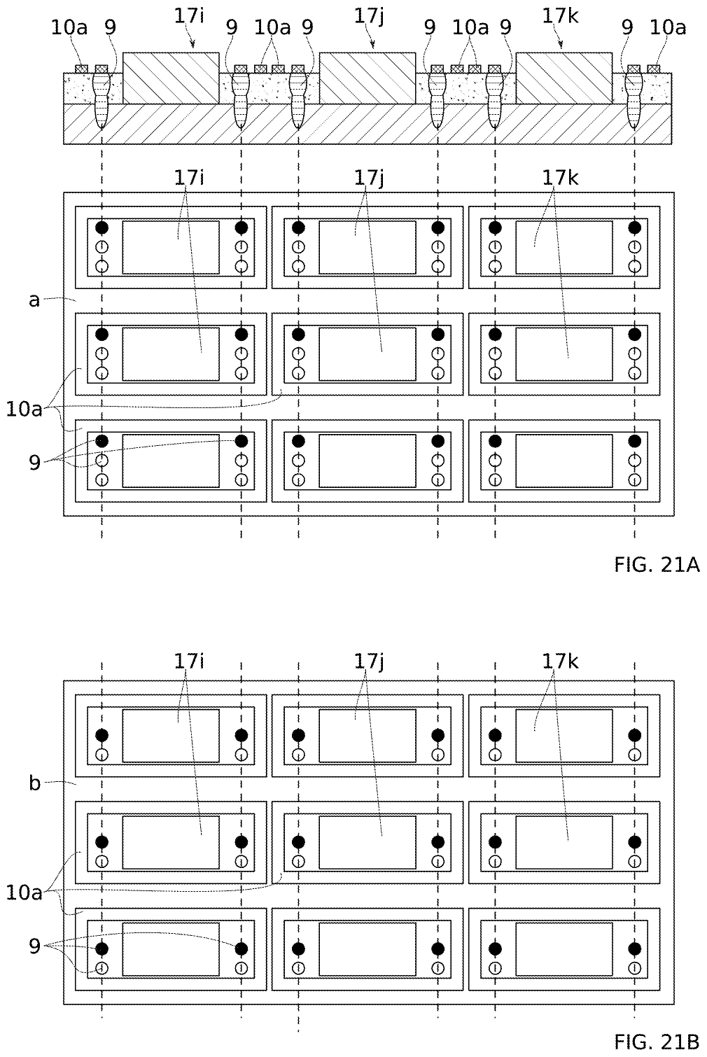

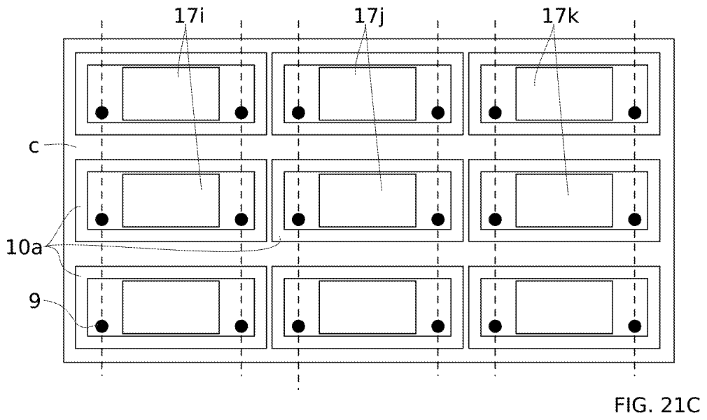

Moreover, sealing elements can also be produced, which will serve to insulate the battery relative to the external environment. In the embodiment presented in FIG. 10, the formation of certain elements is benefited from, in particular the second collector 6 and the contact 94, to make a sealed seam 10a. The latter, which cannot be seen in FIG. 10 as a cross-sectional view, is advantageously configured to form a closed contour around the battery. An example of a contour is given in FIG. 21A for a battery 17i.

The battery thus formed can be electrically connected to make it operational, conventionally. The electrical contact reconnection by the front face presented in FIG. 10 allows this.

Subsequent steps can optionally serve to perform a contact reconnection by the rear face, the second face 12, of the support 1.

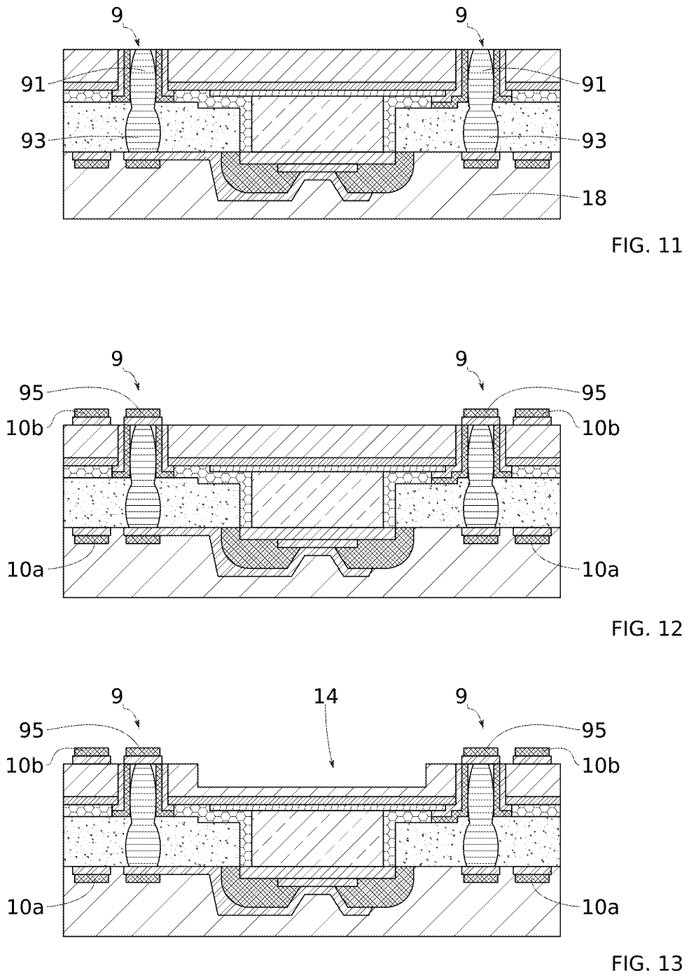

Thus, in FIG. 11, the front face, comprising the battery stack, has been encapsulated in an encapsulation layer 18 (for example, made of polymer), and the second face 12 of the support has been thinned until exposing the electrical connection elements 9, through the bottom of the cavities 13.

The following step of FIG. 12 comprises metal depositions, making it possible to make contact reconnection elements 95 on the rear face of the electrical connection elements 9, for example by a titanium and gold bilayer. As above, this formation can be benefited from, to make another sealed seam 10b, similarly to what is proposed for the sealed seam 10a on the other face. Naturally, the particular embodiment proposed for the sealing is not limiting; it benefits from metal layer depositions and pattern creation phases performed for other purposes. The sealing could absolutely be reproduced by a distinct step.

Generally, according to the invention, it is possible to implement an electrically insulating layer at the interface between the support 1 and all or some of the electrically conductive members of the device presented here, and in particular, when the support 1 is electrically conductive.

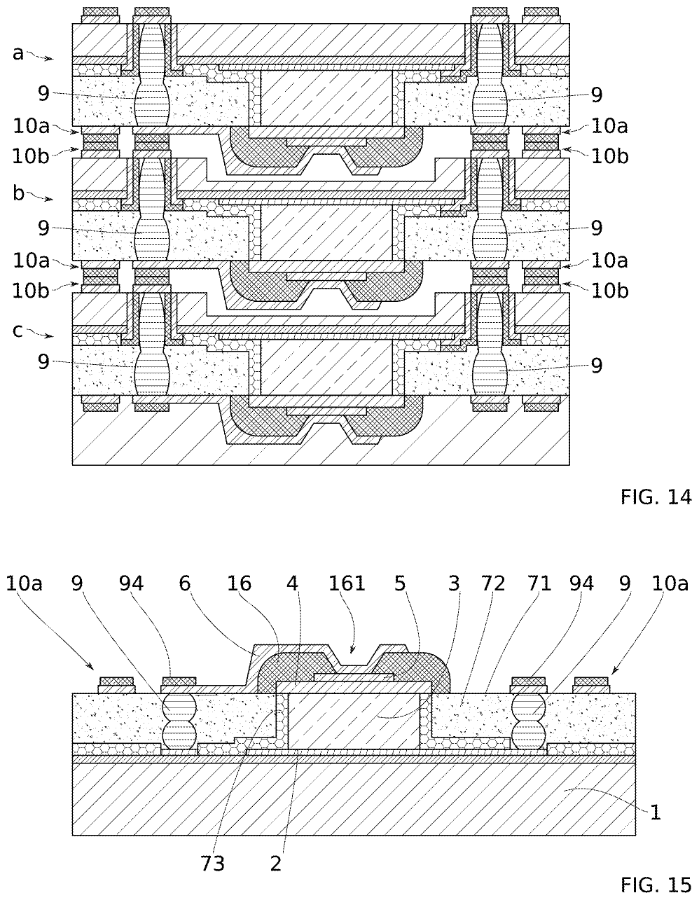

Optionally, a recess 14 can be made in the support, in a zone located facing the battery stack comprising the cathode 3. An etching can be implemented for this purpose. This arrangement defines a volume which can be useful to stack batteries, as is represented in FIG. 14.

Indeed, the recess 14 is configured to receive, at least partially, a superposed battery. An interest of this arrangement is to be able to accommodate the dilatations of the battery during charging.

In the configuration represented in FIG. 14, three levels of batteries a, b, c are superposed. This number is however purely indicative. Preferably, the lower level, level c, has a battery stack encapsulated in a layer 18. By its opposite face, this battery receives a battery of a level b. An electrical connection is produced between these two levels by way of electrical connection elements 9. The mounting here illustrated forms a circuit in parallel, the positive electrodes of the batteries being connected to a common node, formed by the continuity of certain electrical connection elements 9, typically those represented on the right in FIG. 14. Similarly, the anodes of the batteries are here connected by other electrical connection elements 9, which are those on the left in FIG. 14.

An equivalent connection is performed between the levels b and a. The last level, opposite that presented in the lower part of the battery stack, can here serve to the external connection of the battery, by way of the exposed portion of the connection elements 9 that it comprises.

Subsequently, it will be seen that other electrical connection diagrams are possible.

On the other hand, thanks to the sealed seams 10a, 10b, a peripheral assembly of the batteries can be produced, the seams creating an internal volume within which a stack of a battery is located.

The assembly between the levels, whether these are sealed seams 10a, b and/or electrical connection elements 9, can be made by direct gluing, soldering or thermocompression. The advantage of having a gold/gold interface will be noted in this context, through the contact quality obtained and the capacity to cold-glue.

Preferably, the assembly of the batteries is made under vacuum or under a flow of neutral gas, such as argon.

In the integration described above, a part of the substrate, for example silicon, is preserved, which is advantageous for the mechanical strength, in particular when a metal sealing (in particular gold/gold) is implemented. For all that, the stresses and the mechanical strength depend a lot on the surface of the battery. In certain cases, it is possible to completely remove the support 1 and to modify the structure to have a dilatation battery stack volume alternatively in the preceding case.

It is this possibility that FIGS. 15 to 19 show, with, in the case of FIG. 19, a battery stack configuration alternative.

FIG. 15 shows a structure which is quite similar to that obtained in FIG. 10. To achieve this, the description of the preceding embodiment can be referred to, for all the common parts.

Distinctly, a contact reconnection on the front face is preferably sought in FIG. 15, i.e. on the side of the battery stack, to connect the latter to other superposed batteries. Thus, the electrical connection elements 9 do not necessarily cross through the support, in cavities 13, in this option. They can be made above the first face 11 of the support 1. In the example represented in FIG. 15, as above, they have one or more terminals crossing through the thickness of the coating portion, here in the part 72.

Still as above, FIG. 15 shows a coating portion with two successive parties 72, 73, but it is reminded that this embodiment is not limiting. One single part can undergo, or more than two parts can be implemented.

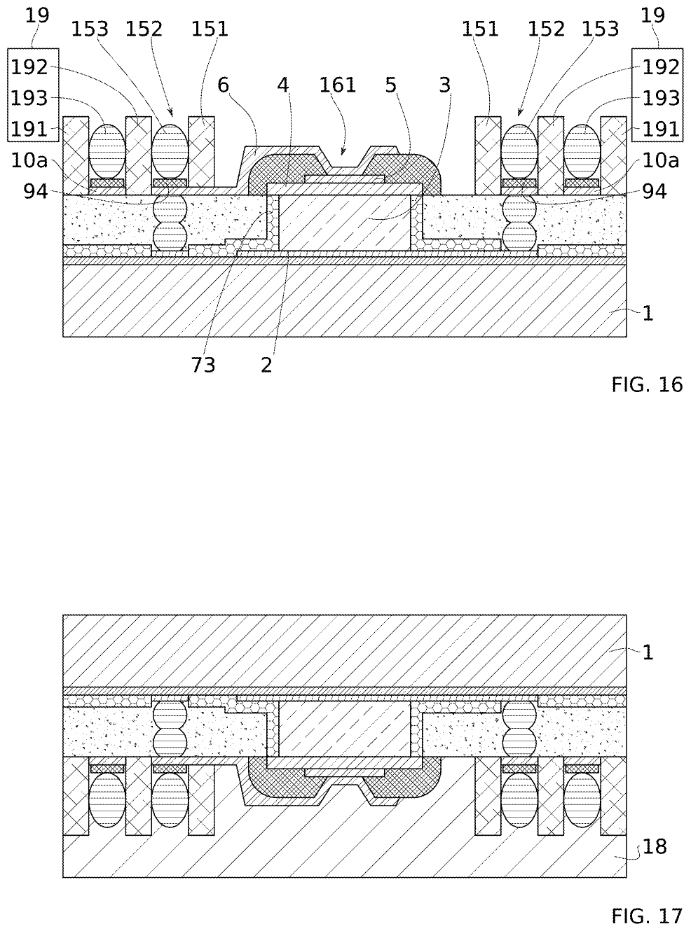

The step of FIG. 16 makes it possible to produce a residual volume around the stack comprising the electrolyte and the anode. To this end, a sealing frame 19 is formed around the battery stack and above the face 71 of the coating portion. The latter has a dimension in thickness greater than that of the battery stack, typically such that a space subsists above this stack, and in particular above the second collector 6.

The sealing frame 19 can be made by way of the formation of an external wall 191 and of an internal wall 192, the interstitial space of which is then filled by a filling material 193. More specifically, lithography and lamination steps can be used to make the walls 191, 192. The filling material 193 can be deposited by screen printing a soldering paste, or by electrolysis.

For the walls, a photosensitive dielectric polymer material of the SiNR type, sold under the trademark Shin-Etsu®, in the form of dry films can be used, or by spin spreading.

As above, but in a non-limiting manner, it is advantageous to proceed with electrical connection construction phases as the same time as the construction of the sealing.

It is what is also proposed in FIG. 16. Thus, a connection trench 152 is defined by means of an additional wall 151 disposed more inside than the inner wall 192 relative to the battery stack. The wall 151 can be made at the same time as the walls 191, 192. Also, a filling of the trench 152 thus defined between the wall 151 and the wall 192 is possible. Soldering paste can also be used. This time, contrary to the filling 193, it is preferably sought to form a discontinuous filling, essentially in electrical continuity of the elements 9, without totally filling the trench 152. The collectors can be electrically connected by way of electrical connection elements, according to different configurations. In particular, as presented in FIGS. 16 to 19, the trench 152 can serve to produce an element 9 in electrical continuity with the second collector 6, below the wall 151 which, in this case, surmounts at least some of the second collector 6 which is thus extended towards the element 9 of the trench 152. However, other situations can be considered, like the preservation of a part of the surface without the wall 151, such that the second collector 6 is not interrupted there.

FIG. 17 has a step similar to that of FIG. 11, with the creation of an encapsulation 18 for a first battery configuration example of a battery assembly to be superposed. This example can constitute an end level of the superposition.

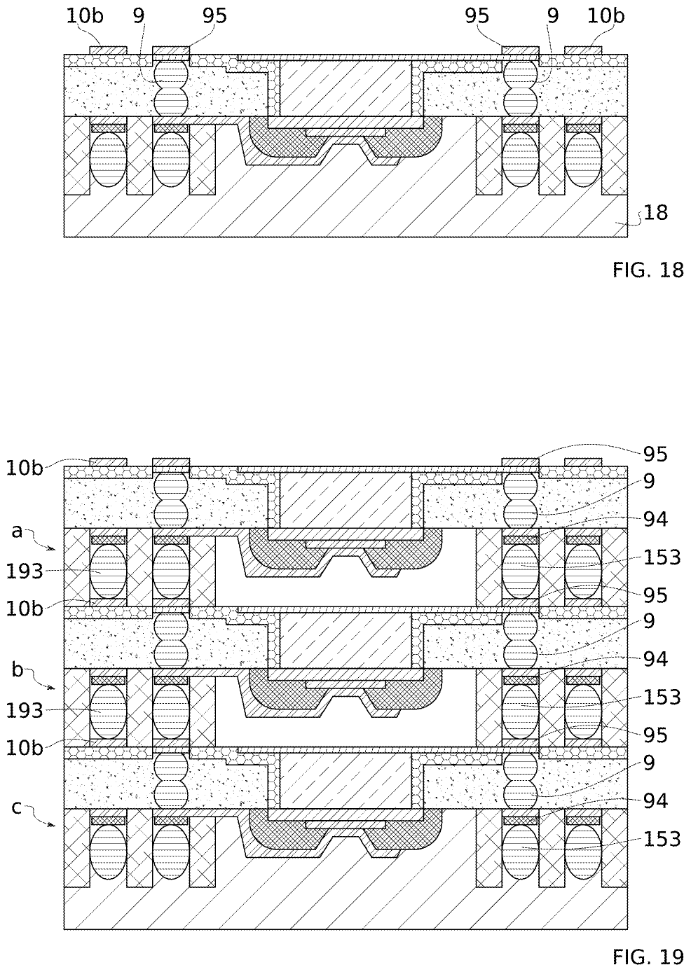

In this embodiment, the initial support 1 is totally removed as FIG. 18 shows. Thus, on the rear face, the support has disappeared and the electrical connection elements 9 are accessible for an electrical connection. As above, this can pass through the formation of a contact reconnection element 95, for example in the form of metallisation, which could comprise a superficial gold layer, and for example, a titanium/gold bilayer.

Still as above, the metallisation phase can be utilised to form the contacts 95 to make sealed seams 10b, being reminded that such seams could be made separately.

On the base of the structure of FIG. 18, other batteries can be superposed, as FIG. 19 shows, with three levels represented. This time, it is the spacer function of the sealing frame 19 which preserves an inner volume of the housing of the battery stacks.

The sealing can be made equivalently to the preceding case, in particular with a gold/gold gluing interface. Likewise, the electrical connection elements 9 can be successively connected by level, according to the desired electrical configuration.

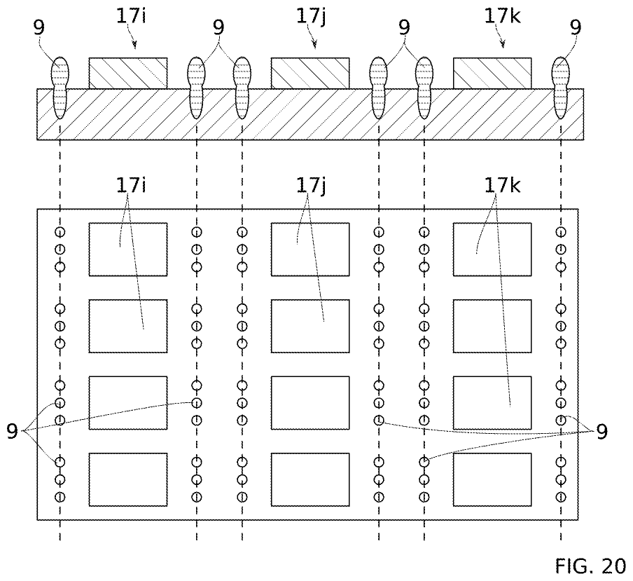

In this regard, FIG. 20 shows different possibilities.

According to an aspect, it illustrates the capacity to have a plurality of batteries 17i, j, k on one same level, with, in the example, a battery matrix 12. In particular, in this case, the batteries can share, at least during manufacture, one same support or also one same coating portion 72, 73. They can then be singled out, or not.

According to another aspect, this figure reflects that the electrical connection elements 9 can be made commonly. For example, one same trench schematised here by a dotted line can be formed to make the cavities 13 or the trenches 152 of several juxtaposed batteries. Then, within these trenches, electrical conduction elements 9 are made in an individualised manner.

It is understood that the batteries proposed here allow a juxtaposed organisation, as FIG. 20 shows, or superposed, as FIGS. 14 and 19 have shown.

The multiple arrangement possibilities are also revealed from FIGS. 21A to 21C. FIG. 21A shows a level a of batteries in view of a superposition with two other levels b, c. This level comprises a plurality of electrical conduction elements 9.

When a connection in series and/or in parallel is to be made between the superposed batteries, two electrical conduction elements 9 by batteries can undergo (one for the anode, one for the cathode).

However, an individual addressing of the superposed batteries can also be proceeded with, so as to connect them individually to the outside. To achieve this, for each succession of superposed batteries, at least twice more of the electrical conduction elements 9 than levels are had. In the case represented, for example, a battery 17i comprises six electrical connection elements (i.e. a sufficient number to electrically connect the two electrodes of each battery, on the three levels).

In this context, two first electrical connection elements 9 will serve as the electrical connection of the battery 17i of this level, which is schematised in FIG. 21A by a grey filling of the two corresponding elements 9. The four other elements 9 of a battery 17i, j, k will serve as the electrical continuity to batteries of other levels.

Thus, FIG. 21B shows a level of batteries b, wherein two connection elements 9, schematised by a grey filling, in the continuity of two electrical connection elements 9 of the preceding level a, will serve to electrically connect the cathode 3 and the anode 5 of a battery 17i, j, k of the level b.

Finally, the batteries of the level c comprise two connection elements 9 for the connection of their cathode and of their anode. These elements are in the continuity of elements 9 of the low levels.

Thus, batteries of different levels can be individually connected, through electrical connection through structures, formed by the superposition of connection elements 9.

In the solution represented in FIGS. 21A to 21C, all the batteries of the battery system are independent. All or some of the batteries of a level could also be connected in series or in parallel, and each level be electrically connected independently, without moving away from the scope of the invention.

The invention is not limited to the embodiments described above, and extends to all the embodiments covered by the invention.

1. A battery comprising, stacked successively above a first face of a support, in a stacking direction, at least:
a cathode comprising a lower face, an upper face and a side wall directed in the stacking direction from the lower face to the upper face,
a solid electrolyte,
an anode,
a coating portion surrounding, and in contact with, all of the side wall of the cathode, without covering the upper face of the cathode, the coating portion comprising an upper face, and
at least one electrical connection element crossing through the coating portion and leading to the upper face of the coating portion and on a second face of the support, opposite the first face.

2. The battery according to claim 1, wherein the upper face of the cathode is flat and wherein the upper face of the coating portion has at least one flat portion in the continuity of the upper face of the cathode.

3. The battery according to claim 1, wherein the coating portion comprises a main portion made of a first material and a contact coating, made of a second material, different from the first material, the contact coating being in contact with the side wall of the cathode and disposed between the main portion and the side wall of the cathode.

4. The battery according to claim 1, wherein the at least one electrical connection element comprises at least one terminal made of an electrically conductive material.

5. The battery according to claim 1, comprising a first current collector in electrical continuity with the cathode, a second current collector in electrical continuity with the anode and wherein the at least one electrical connection element comprises at least one first electrical connection element connected to the first current collector and at least one second electrical connection element connected to the second current collector.

6. A system comprising a plurality of batteries according to claim 1.

7. The system according to claim 6, wherein the plurality of batteries are superposed.

8. The system according to claim 7, wherein at least one electrical connection element of one of the batteries is in electrical continuity with an electrical connection element of at least one other of the batteries.

9. A method for manufacturing a battery, comprising a formation of a stack successively comprising, in a stacking direction, on a first face of a substrate, at least:
a cathode comprising a lower face, an upper face and a side wall directed in the stacking direction from the lower face to the upper face,
an electrolyte,
an anode,
wherein the method comprises:
forming a coating portion surrounding, and in contact with, all of the side wall of the cathode, without covering the upper face of the cathode, the forming the coating portion comprising:
i. forming a coating layer so as to fully cover the cathode;
ii. thinning the coating layer until exposing the upper face of the cathode, the thinning comprising at least one polishing,
forming at least one electrical connection element,
thinning the support by a second face of the support opposite the first face,
the polishing being configured to expose the at least one electrical connection element on the upper face of the coating portion and the thinning of the support being configured to expose the at least one electrical connection element on the second face of the support.

10. The method according to claim 9, wherein the forming the coating layer comprises the formation of a coating layer made of a first material on, and in contact with, the cathode, then the formation of a main layer made of a second material, different from the first material, on, and in contact with, the coating layer.

11. The method according to claim 10, wherein the first material is chosen more mechanically resistant to the polishing than the second material.

12. The method according to claim 10, wherein the polishing is applied to the main layer, by using the coating layer as a polishing stop layer.

13. The method according to claim 12, comprising an etching of the coating layer, after polishing, to expose the upper face of the cathode.

14. The method according to claim 9, wherein the polishing is applied until exposing the upper surface of the cathode.
